(19) United States
(12) Patent Application Publication
(10) Pub. No.: US 2020/0174990 A1
(43) Pub. Date: Jun. 4, 2020

(54) Accountably Redactable Data Structures

(71) Applicant: Anthony Turner Pratkanis, Sunnyvale, CA (US)

(72) Inventor: Anthony Turner Pratkanis, Sunnyvale, CA (US)

(21) Appl. No.: 16/203,793

(22) Filed: Nov. 29, 2018

(51) Int. Cl. G06F 16/23; H04L 9/32; H04L 9/06; G06F 16/901

(52) U.S. Cl. CPC G06F 16/2365; H04L 9/3221; H04L 2209/38; H04L 9/0637; G06F 16/901; H04L 9/0643

(57) ABSTRACT

A system and method of accountably redacting selected data from a blockchain, distributed ledger, or other Merkle-Linked (or partial Merkle-Linked) data structure are disclosed. In accordance with some implementations, such a system and method may generally comprise or enable redacting selected elements from a data element and using a proof to show that the redaction was performed correctly; in this manner, it may not be necessary to retain the original version of redacted data element, since the redacted version and the proof are enough to maintain system integrity.

### FIELD OF THE DISCLOSURE

Aspects of the disclosed subject matter relate generally to blockchains and other Merkle-Linked data structures, and more particularly to a system and method of accountably redacting selected data from a blockchain or other Merkle-Linked data structure.

### BACKGROUND

Merkle-Linked data structures are conventional data structures (such as trees and lists, for example) in which some, many, or all of the elements of the structure are linked, typically using collision resistant hash functions. A collision resistant hash function is a function that takes in as its input some data or data set (that is potentially quite large) and compresses those data to a small hash fingerprint. The fingerprint does not reveal any useful information regarding the original data provided to the hash function, but may nevertheless serve to identify those original data. One popular hash function is SHA-256 which has been standardized in accordance with the Federal Information Processing Standard (FIPS) as PUB 180-4, though many others are generally known in the art and used for a variety of purposes.

In many conventional applications, as noted above, collision resistant hash functions may be used to create Merkle-Linked data structures. It will be appreciated that, as used herein, the term “Merkle-Linked data structures” generally refers to acyclic graphs of data elements, such as trees and lists, instances of which may be produced by encoding the hash of child elements into parent elements. In that regard, FIG. 1 is a block diagram illustrating a simple Merkle-Linked data structure comprising a tree of five elements. Specifically, in the FIG. 1 implementation, data structure 100 generally comprises five data elements (reference numerals 101-105). Data elements 101-105 may contain any data, although a system designer or administrator may elect to enforce rules or requirements on these data governing, regulating, or otherwise controlling or specifying the manner in which data elements 101-105 are linked, processed, associated, or otherwise manipulated in the context of a particular system; as set forth in detail below, such rules may be system- or application-specific, and may be selected as a function of a variety of considerations. In the FIG. 1 representation, data elements 101, 102, and 103 are represented as child elements, while data elements 104 and 105 are represented as parent elements; this convention is used consistently throughout the present disclosure, although it is noted that some authors may reverse this nomenclature, referring to data elements 101, 102, and 103 as parents, rather than children, and to data elements 104 and 105 as children, rather than parents.

In a typical Merkle-Linked data structure (such as data structure 100), parent elements (such as 104 and 105) must include the hashes of their children as represented in FIG. 1. It is noted that, in the FIG. 1 implementation, data element 104 is both a parent (to data elements 101 and 102) and a child (of data element 105).

Those of skill in the art will appreciate that, as represented in FIG. 1, HQ may generally represent a collision-resistant hash function, and that a hash of any particular data element 101-105 may be computed by appending the hashes of children, if they exist, and element data, and then computing the hash of these appended data (see, e.g., data elements 104 and 105).

Merkle-Linked data structures have the property that each parent (such as data elements 104 and 105) cryptographically validates its child node (or children nodes, if a plurality exists); accordingly, by specifying the hash of a single parent element (or a suitable set of parent elements), an entire data structure 100 may be recursively validated. In FIG. 1, for example, specifying the hash of data element 105 may be enough to validate data structure 100 in its entirety; in more complicated structures, however, it may be necessary or desirable to identify or otherwise to specify the hash of more than one parent element to enable reconstruction and validation of the entire data structure. In many instances, such a validation process may be simple, because it generally entails only two processes: ensuring that child or children hashes are correct; and applying any internal rules or instruction sets that are or have been designated by a system designer to validate the structure of the data elements.

Typically, when referenced via a given set of parent nodes, Merkle-Linked data structures are immutable, meaning that the existing data elements cannot be altered; while additional data elements may be appended to the data structure, existing elements may be neither deleted, altered, nor redacted. The fact that data elements in Merkle-Linked data structures may generally be referenced by hashes means that they can be stored efficiently in hash tables, distributed hash tables, other types of conventional file systems, or a combination of these or other data storage paradigms. In that regard, FIG. 2 is a diagram illustrating one example of a representation of a Merkle-Linked data structure in a hash table.

In connection with, among other things, certain cryptographic and other digital telecommunications or authentication methodologies, some researchers and practitioners have employed mechanisms known as Non-Interactive Zero-Knowledge Proofs (NIZKPs) for a variety of purposes. In practice, NIZKPs are mathematical constructs or techniques that generally allow one processing system, software application, device, or a combination thereof (a “prover”) to generate a proof (or other representation or indicium) that a problem or puzzle has been solved, without the necessity for the prover to reveal the actual answer or solution. The proof may then be transmitted, disseminated, broadcast, or otherwise communicated to a second processing system, software application, device, or a combination thereof (a “validator” or “verifier”) that may acknowledge that the prover has computed a valid solution, without the necessity for the verifier to receive, review, or even to have any knowledge of the solution itself.

The proof is generally a relatively small piece or series of binary data, though other alternatives are known in the art to be suitable for this purpose. For example, the proof may be in a base other than binary, such as octal, decimal, hexadecimal, or the like, depending upon a desired application, or the proof may be a relatively large piece or series of data, irrespective of the base employed. Mathematically, a NIZKP is defined as a proof that f(x, y)=1, where f is a publicly available function, x is a publicly available value, and y is a value kept private by the prover. Those of skill in the art will appreciate that a proof taking the form of f(x, y)=0 may also be used for the same purpose, generally as a design choice or as a function of the application in connection with which a particular proof is used. In that regard, it is also worth noting that x and y may be arbitrarily complex, and that the output and the check operator may be selected in accordance with application-specific factors or as a design choice. Specifically, the form f(x, y)=1 is provided by way of example only; a NIZKP may be defined, for instance, as a proof that f(x, y)>π+2^{x}, or f(x, y)<n where n is an integer.

Some commercial or otherwise publicly available examples of NIZKP techniques are ZK-SNARKs, ZK-STARKs, and Bullet Proofs, though the present disclosure is not intended to be limited to any particular implementation. It is noted that the term “Non-Interactive” in the acronym NIZKP typically implies that no communication back from the verifier (to the prover) is necessary for verification or validation of the proof. In the context of the present disclosure, the term “Zero-Knowledge Proof” is generally meant to encompass NIZKPs, and thus, unless otherwise specified or the context requires, a general reference to zero-knowledge proofs includes the qualifier that such proof is non-interactive. It is also noted that the following techniques may employ other proofs that are neither non-interactive nor zero-knowledge. Where the functionality of a particular proof satisfies the conditions or requirements identified with respect to a particular implementation, the characterization of such a proof is irrelevant.

In addition to mathematical NIZKPs, trusted hardware platforms or other data processing hardware may also be able to implement “Sealed Glass Proofs” or other technologies which can be used as an equivalent or functionally similar construct, assuming the hardware manufacture is trusted. In that regard, though some of the following description is provided in terms of software, instruction sets, or modules, it will be appreciated that the underlying functionality may be provided entirely in, or supported by, suitable hardware or firmware implementations.

FIG. 3 is a functional block diagram illustrating one process of using a Non-Interactive Zero-Knowledge Proof in connection with one disclosed implementation. In FIG. 3, a system 300 generally comprises a prover computer, data processing system, or other device (operating in cooperation with software as is generally known) as indicated at reference numeral 310 and a verifier computer, data processing system, or other device (operating in cooperation with software as is generally known) as indicated at reference numeral 330. Prover computer 310 and verifier computer 330 generally have access to shared data 320.

Prover computer 310 generally comprises NIZKP generation software (or hardware) 312 operative to act on a private argument (y) 311 and a public argument (x) 323 in accordance with a public function (f) 322 to produce a proof 321. In that regard, as is generally known in the art, function (f) 322 may be an arbitrary or otherwise selectable mathematical function (or “puzzle”), selected by a system designer, for example, to be proven or solved; it is noted that any of various NIZKP functions such as ZK-SNARKs, ZK-STARKs, and Bullet Proofs, may be suitable for solving function (f) 322 to generate proof 321, and that other proofs (e.g., those that are neither non-interactive nor zero-knowledge) may also have utility in the context of the functionality described below. Verifier computer 330, on the other hand, generally comprises NIZKP verification software (or hardware) 331 operative to verify proof 321 as indicated at reference numeral 332. In particular, given argument (y) 311, which is unknown to verifier computer 330, as well as argument (x) 323 and function (f) 322, verifier computer 330 may confirm proof 321 notwithstanding that argument (y) 311 is unknown and unknowable.

Currently, existing techniques for redacting a Merkle-Linked data structure (such as structure 100) comprise either (i) storing both an initial version as well as a redacted version of a data element that has been redacted, or (ii) storing only the redacted version. The former approach has the advantage that the accountability of the redaction can be verified by comparing the original and redacted values, but it also includes a material disadvantage, specifically, that the original value, which is obsolete, is nevertheless retained and not truly deleted—this is a waste of memory resources and results in larger table sizes than are necessary for an efficient system. In the latter approach, on the other hand, while the original data element is truly deleted from the system (freeing memory, reducing table size, and eliminating the potential that undeleted data are misappropriated or accessed by an unauthorized party), the accountability of the redaction can no longer be verified, as there is no longer an original record against which a redacted element may be verified or validated.

From at least the foregoing, it will be appreciated that what is needed is a system and method of redacting information from a Merkle-Linked data structure, so that information may be removed from the system while preserving other desired or immutable properties (e.g., financial integrity, user permissions, and data authenticity). In some instances, it may be desirable to use NIZKP techniques to verify the integrity of data after redaction. As defined below, some functional aspects of a disclosed system and method may be referred to as practicing “accountable redaction.”

### SUMMARY OF THE DISCLOSURE

The following presents a simplified summary of the disclosure in order to provide a basic understanding of some aspects of various embodiments disclosed herein. This summary is not an extensive overview of the disclosure. It is intended neither to identify key or critical elements of the disclosed embodiments nor to delineate the scope of those embodiments. Its sole purpose is to present some concepts of the invention in a simplified form as a prelude to the more detailed description that is presented later.

The present disclosure describes a system and method using Non-Interactive Zero-Knowledge Proofs (NIZKPs) to verify integrity of data after redaction from a Merkle-Linked data structure, such as a blockchain. The disclosed subject matter may have applications with respect to or in cooperation with many types of data in a Merkle-Linked data structure, including, for instance, static content (memo fields), numeric values, encrypted data, confidential transactions, cryptocurrrency addresses, and NIZKP functions, as well as a variety of other applications generally known in the art that may benefit from the functionality set forth below. Redaction of data from blockchains and other Merkle-Linked data structures is of increasing importance due to the implementation of data protection laws such as the European Union's General Data Protection Regulation (GDPR) and California's AB-375 legislation. Additionally, redaction may facilitate removal of data that were erroneously entered into such data structures, or to re-encrypt encrypted data in such systems.

In accordance with one aspect of the disclosed subject matter, a method of accountably redacting selected data from a data structure may be summarized as comprising: identifying an original data element in the data structure having a data field to redact; selectively redacting the data field from the original data element and leaving an unredacted data field unchanged; applying a proof to verify results of said selectively redacting; responsive to the selectively redacting and the applying a proof, generating a new data element comprising the unredacted data field and the proof; and replacing the original data element with the new data element in the data structure.

Methods are disclosed wherein the identifying comprises determining that the data field to redact contains personally identifiable information, and other methods are disclosed wherein the identifying comprises determining that the data field to redact contains copyrighted material.

In some implementations, the selectively redacting comprises utilizing a redaction function. Some methods are disclosed wherein the utilizing a redaction function comprises overwriting values in the data field to redact.

In some implementations, the applying a proof comprises comparing a known hash of the original data element with a hash of data used by the proof. As set forth below, the applying a proof may generally comprise utilizing a non-interactive zero knowledge proof (NIZKP). In accordance with some implementations, the NIZKP uses the original data element as a private argument. Some methods are disclosed wherein the applying a proof comprises ensuring that a hash of data used by the NIZKP is the same as a known hash of the original data element.

In accordance with one aspect of the disclosed subject matter, the data structure may be a blockchain, and the new data element does not violate a rule of the blockchain; the generating may generally comprise associating the new data element with a hash.

In accordance with another implementation, a non-transitory computer-readable medium encoded with data and instructions enabling accountable redaction of selected data from a data structure is disclosed; the data and instructions may generally cause an apparatus executing the instructions to perform a method comprising: identifying an original data element in the data structure having a data field to redact; selectively redacting the data field from the original data element and leaving an unredacted data field unchanged; applying a proof to verify results of the selectively redacting; responsive to the selectively redacting and the applying a proof, generating a new data element comprising the unredacted data field and the proof; and replacing the original data element with the new data element in the data structure.

Some methods are disclosed wherein the identifying comprises determining that the data field to redact contains personally identifiable information; in some instances, the identifying comprises determining that the data field to redact contains copyrighted material. Methods are disclosed wherein the selectively redacting comprises utilizing a redaction function.

In accordance with another implementation, a redacted data element for use in connection with a data structure may be summarized as generally comprising: an unredacted data field from an original data element in the data structure; and a proof to verify that an additional data field from the original data element has been redacted in the redacted data element and that no other data field from the original data element has been modified; wherein a second hash associated with the redacted data element is derived from a first hash associated with the original data element.

Redacted data elements are disclosed wherein the proof comprises a non-interactive zero knowledge proof (NIZKP); in some implementations, the NIZKP uses the original data element as a private argument to derive the second hash.

Implementations are disclosed wherein the proof is operative to ensure that the second hash is derived from the first hash. Redacted data elements are disclosed wherein the data structure is a blockchain; in some instances, the additional data field may comprise personally identifiable information. The additional data field may be embodied in or comprise an address; additionally or alternatively, the additional data field may comprise copyrighted material.

The foregoing and other aspects of various disclosed implementations will be apparent through examination of the following detailed description thereof in conjunction with the accompanying drawing figures, in which like reference numerals are used to represent like components throughout, unless otherwise noted.

### DESCRIPTION OF THE DRAWING FIGURES

FIG. 1 is a block diagram illustrating a simple Merkle-Linked data structure comprising a tree of five elements;

FIG. 2 is a diagram illustrating one example of a representation of a Merkle-Linked data structure in a hash table;

FIG. 3 is a functional block diagram illustrating one process of using a Non-Interactive Zero-Knowledge Proof in connection with one disclosed implementation;

FIG. 4 is a block diagram illustrating a simple blockchain data structure;

FIG. 5 is a block diagram illustrating one approach to redaction of a first element of a two-element Merkle-Linked data structure;

FIG. 6 is a diagram illustrating a representation of the data structure of FIG. 5 in a table;

FIG. 7 is a flow diagram illustrating aspects of the operational flow of one embodiment of a method of accountable redaction;

FIG. 8 is a diagram illustrating a database update, in the form of a table, that may result from the redaction approach depicted in FIG. 7;

FIG. 9 is a block diagram illustrating one implementation of a distributed ledger data structure (such as a blockchain) including a redaction transaction before an original version of a redacted data element has been deleted;

FIG. 10 is a block diagram illustrating the distributed ledger data structure of FIG. 9, after redaction;

FIG. 11 is a diagram illustrating a database state, in the form of a table, prior to application of the redaction approach depicted in FIGS. 9 and 10;

FIG. 12 is a diagram illustrating a database update, in the form of a table, that may result from the redaction approach depicted in FIGS. 9 and 10;

FIG. 13 is a functional flow diagram illustrating one aspect of a redaction transaction propagating across nodes in a distributed ledger data structure system;

FIG. 14 is a functional flow diagram illustrating another aspect of a redaction transaction propagating across nodes in a distributed ledger data structure system

FIG. 15 is a diagram illustrating aspects of a state of each node in a distributed ledger data structure system following acknowledgement of a redaction transaction;

FIG. 16 is a functional block diagram illustrating aspects of a node structure enabling verifiable redaction using trusted hardware;

FIG. 17 is a block diagram illustrating aspects of a redaction technique implementing a nonce change;

FIG. 18 is a diagram illustrating aspects of a data structure employing one approach to validating cryptocurrency addresses;

FIG. 19 is a diagram illustrating one approach to redacting a hash from a data element;

FIG. 20 is a diagram illustrating a database update, in the form of a table, that may result from the redaction approach depicted in FIG. 19;

FIG. 21 is a diagram illustrating one data structure modification having utility in redaction of transaction fees in a bitcoin-style blockchain;

FIG. 22 is a diagram illustrating one data structure modification having utility in redaction of signatures from a data element;

FIG. 23 is a diagram illustrating a data structure of a confidential transaction both before and after certain outputs are redacted;

FIG. 24 is a diagram illustrating one implementation of redaction of a zero-knowledge proof;

FIG. 25 is a diagram illustrating one implementation of a redaction process for performing multiple redactions of a single data element;

FIG. 26 is a diagram illustrating one data element modification facilitating a redaction to delete a child data element;

FIG. 27 is a diagram illustrating one data element modification facilitating re-encryption of data in an asymmetric cryptosystem in which it is not necessary to know a private key for original data;

FIG. 28 is a diagram illustrating one data element modification facilitating redaction with encryption of existing data;

FIG. 29 is a diagram illustrating one implementation of unredaction using trusted hardware;

FIG. 30 is a diagram illustrating one implementation of unredaction of data without a nonce; and

FIG. 31 is a diagram illustrating one implementation of redaction of data with partial hashes.

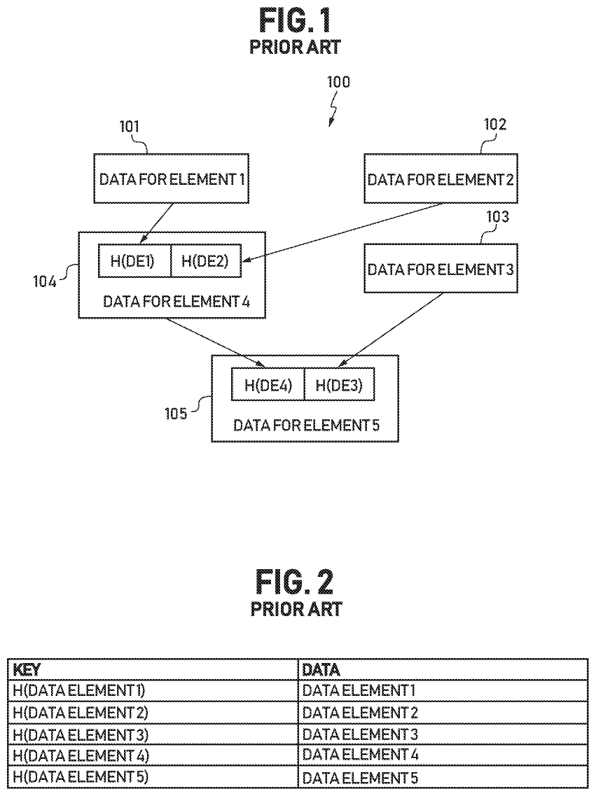

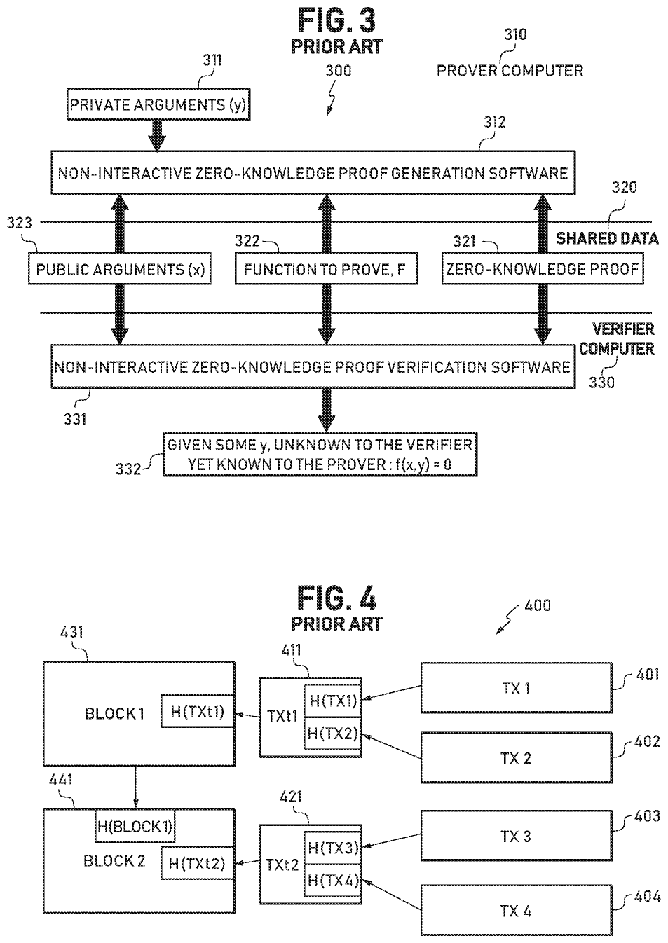

### DETAILED DESCRIPTION

Certain aspects and features of the disclosed subject matter may be further understood with reference to the following description and the appended drawing figures. In operation, a system and method of accountably redacting selected data from a blockchain, distributed ledger, or other Merkle-Linked (or partial Merkle-Linked) data structure may generally comprise identifying an element of the data structure to redact and generating a redacted version of the data element, using a Non-Interactive Zero-Knowledge Proof (NIZKP) system to prove that the redacted version has been redacted in a manner that satisfies a pre-determined rule or set of rules, and creating a redaction transaction record that contains an identifier or other indicum or indicia related to or associated with the data element that has been redacted, the redacted version of the data element, and the NIZKP.

Turning now to a practical example, those of skill in the art will appreciate that a blockchain or distributed ledger may be produced by applying validation rules to a Merkle-Linked data structure, a partial Merkle-Linked data structure, or a data structure having similar architecture, functionality, or both, and using a distributed consensus mechanism to choose a root parent data element or set of root data elements. Typically, the distributed ledger may be spread (or “distributed”) across a set of different physical or logical computing devices, processing systems, terminals, or other apparatus suitable for digital data processing. In the context of the present disclosure, and for simplicity, these apparatus are generically referred to as “computers,” but the disclosed subject matter is not so limited, and is not intended to be restricted to any particular hardware infrastructure, network or telecommunications protocol, device paradigm, or the nomenclature used to characterize the data structure. In practice, each of the distributed computers implementing blockchain or distributed ledger methodologies is referred to as a “node,” and each such computer (at least by virtue of the distribution) may or may not be owned, leased, operated, or controlled by the same organization, depending on the use case, system integration issues, security concerns, or a combination of these and a variety of other considerations.

It is noted that a distributed consensus mechanism implemented by a blockchain system (and other structurally or functionally similar or analogous systems, including distributed ledgers, Merkle-Linked, or partial Merkle-Linked data structures) may be embodied in or comprise any of numerous mechanisms generally known in the art having utility for such an application. By way of example and not by way of limitation, a distributed consensus mechanism (for any of the foregoing or functionally similar systems) may employ a proof-of-work, proof-of-stake, or other similar approach or methodology. Most consensus algorithms use a two-step approach: first, each new element in the data structure (i.e., the “chain”) is built upon the “best” data element or set of elements selected by an appropriate or desired algorithm; second, at some future point in time, a given data element and its history are “locked in,” usually after a pre-determined number of parent elements are built on top of a given element; it is noted that this number of parent elements may be dynamically or otherwise selectively adjustable in some circumstances, and need not be pre-determined or set as a universal variable in the blockchain construction method. This locking in procedure (also called “checkpointing”) with respect to a particular data element also locks in, associates, or creates a known relationship between the particular data element and its children due to the immutable nature of the Merkle-Linked data structure.

The set of root parent data elements that is selected by consensus is generally referred to as the “head” of the distributed ledger. Additional validation rules of the Merkle-Linked (or partial Merkle-Linked, or similar) data structure may be determined, selected, designed, or otherwise created to ensure proper or predictable behavior of the blockchain or other distributed ledger system. For example, in a financial blockchain, it may be desirable that each transaction involving a monetary transfer be validated to ensure that a transaction does not (unintentionally or otherwise) “print money” by altering a total amount of money in a closed financial system; in a medical records blockchain, it may be desirable that content digital signatures be validated to ensure that specific content was inserted by a specific user with proper or correct permissions.

By way of background, FIG. 4 is a block diagram illustrating a simple blockchain data structure. In the FIG. 4 implementation, a basic blockchain 400, such as may be used for Bitcoin™ transaction, generally comprise four transactions TX1-TX4 (reference numerals 401-404), each of which is a data element in the Merkle-Linked data structure. Transactions 401 and 402 are represented as children of TXt1 (reference numeral 411), which is itself represented as a child of Block 1 (reference numeral 431); similarly, transactions 403 and 404 are represented as children of TXt2 (reference numeral 421), which is itself represented as a child of Block 2 (reference numeral 441). As indicated by the hash functions, Block 1 431 is also a child of Block 2 441.

As noted above, data cannot be removed from or modified within a Merkle-Linked data structure, since these data structures are immutable. If a data element were modified, the hash of the element changes (since the data are now different); as a consequence, the parent of such a modified data element will no longer have a valid hash. Modifying any and all parent data elements with new child hashes recursively causes grandparent data elements to fail validation due to altered hashes of the parents, and so on. The cycle repeats and propagates upwards through the data structure, requiring modification of every parent element of an altered child in order to pass validation.

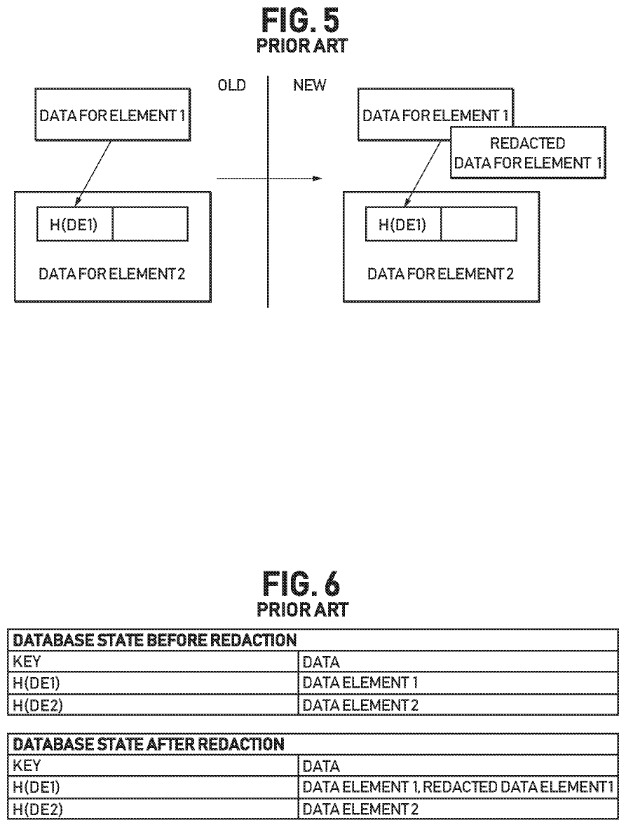

As noted above, conventional techniques for redacting a Merkle-Linked data structure suffer significant disadvantages. For instance, storing both the initial version and the redacted version of a data element facilitates verification of the redaction (since a comparison with original, unredacted data is still possible), but requires more memory and larger table sizes than otherwise would be necessary. On the other hand, storing only the redacted version, while economizing on memory, eliminates the possibility of verifying the redaction, as the original (unredacted) data element is deleted and no longer available for comparison. The former approach is illustrated in FIGS. 5 and 6.

Specifically, FIG. 5 is a block diagram illustrating one approach to redaction of a first element of a two-element Merkle-Linked data structure, and FIG. 6 is a diagram illustrating the data structure of FIG. 5 in a table. In the illustrated example, an old (original, unredacted) data element (DE1) is shown on the left of FIG. 5 and at the top of FIG. 6, and the new (redacted) version of DE1 is shown on the right of FIG. 5. It is noted that the table depicted at the bottom of FIG. 6 is represented as storing both old (i.e., original) and new (i.e., redacted) values for data element 1 (specifically, H(DE1)). This approach, i.e., storing both an original version and a redacted version of a data element, allows accountability, but defeats the purpose of redaction, because the original value is preserved. In accordance with one aspect of the disclosed subject matter, accountability may be achieved without the necessity of preserving the original data element.

The disclosed “accountable redaction” methodologies, which, as noted above, generally involve redaction that may only modify specific targeted aspects of data fields within a particular data element and not other aspects, may mitigate or eliminate many of the foregoing deficiencies. Heretofore, there has been no way to redact fields of a Merkle-Linked data structure in an accountable manner without either preserving an original, unredacted version at the expense of efficiency (see, e.g., FIGS. 5 and 6) or blindly trusting that any such redaction was performed accountably, at the expense of security. By way of example, and not by way of limitation, some typical considerations influencing operational characteristics of an accountable redaction technique may be apparent from the following anecdote: in a system in which a data element may comprise account numbers, names, addresses, and telephone numbers of participants in a financial transaction, as well as a dollar amount associated with the transaction, it may be desirable, or it may become necessary in some circumstances, to delete or otherwise to anonymize the names, mailing addresses, and telephone numbers of the participants; in this situation, however, deletion or modification of account numbers of the participants and the transaction dollar amount or value must almost always be prevented (as such a deletion may cause the transaction to fail, or may allow or facilitate financial fraud by manipulation of the ledger). In light of the foregoing, it will be appreciated that unaccountable redaction is clearly unacceptable for many applications, such as the financial transaction described above, particularly those that exploit the cryptographic verifiability of Merkle-Linked data structures.

One disclosed approach to the challenges experienced in traditional approaches comprises development of a system and methodology that allow accountable redaction of a Merkle-Linked data structure by using NIZKPs. In accordance with one implementation, for instance, a designer of a Merkle-Linked data structure may define, a priori or otherwise, a function (say, is_safe_redact, for instance) that receives an old (original, unredacted) version of a data element and a proposed new (redacted) version; in operation, and to ensure accountability, such a function must return true if, and only if, the redaction is successful (i.e., the condition defined by the NIZKP is satisfied). Specifically, the computer or other instrumentality redacting the Merkle-Linked data structure may execute a process specifically directed to ensuring that the redaction is accountable as set forth herein.

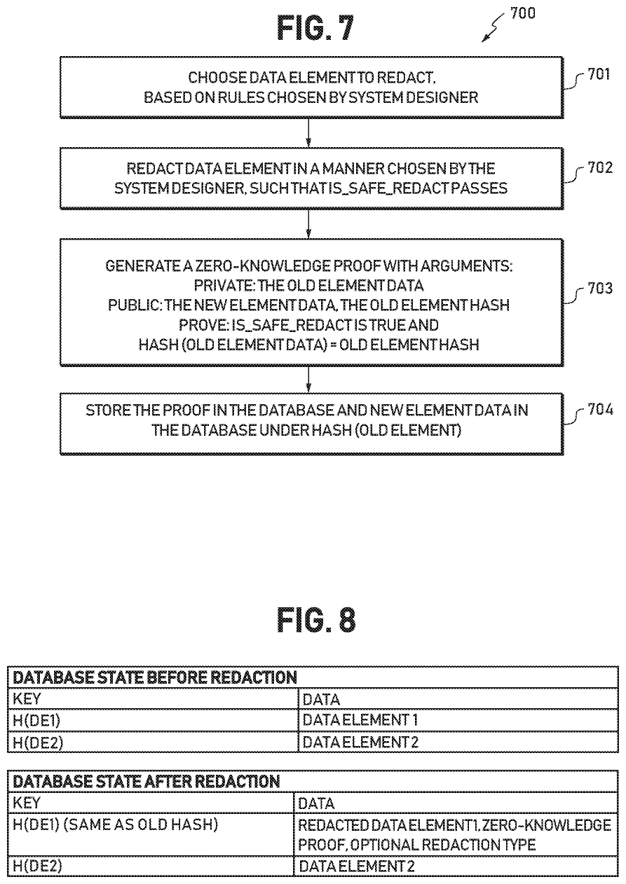

In that regard, FIG. 7 is a flow diagram illustrating aspects of the operational flow of one embodiment of a method of accountable redaction, and FIG. 8 is a diagram illustrating a database update, in the form of a table, that may result from the redaction approach depicted in FIG. 7. In FIG. 8, a state of a database maintaining records of a distributed ledger after desired redaction of a specific data element is illustrated at the bottom of the drawing figure. In the FIG. 7 implementation, a method of accountable redaction (reference numeral 700) may begin with a computer or other suitable apparatus or instrumentality identifying, selecting, or otherwise determining a data field to be redacted from a data element, as indicated at block 701. Such a choice, selection, or determination may depend, for example, on decisions made by a system designer, the nature, level of confidentiality, or sensitivity of the data elements to be handled or the transactions that are contemplated, the (expected or projected lowest, median, or highest) processing capabilities of system nodes and the telecommunications bandwidth of networking or other distributed hardware infrastructure accommodating communications between them, cryptographic parameters that are suggested or required by enterprise operators or governing laws or regulations, or a combination of these and/or a variety of other factors that are generally known in the art. As noted briefly above, the present disclosure is not intended to be limited by any particular hardware application or networking architecture supporting the interoperability of specific network nodes, nor by any particular hardware, firmware, or software configuration at a particular node or set of nodes, such as may be embodied in or comprise a computer performing any of the processes illustrated and described with reference to FIG. 7 or any other drawing figure.

As indicated at block 702, a computer may perform a redaction of a data element; the redaction may be executed, performed, or effectuated as defined or specified by a designer or coder, for instance, or otherwise in accordance with some or all of the parameters noted above. It is noted that the result of such a redaction is generation or computation of a new version of the specific data element that has been redacted. In some instances, it may be true that the new, redacted version of the data element (see, e.g., the bottom of FIG. 8) must be accepted, validated, authorized, acknowledged, or otherwise verified by a governing function (in this case, “is_safe_redact”) given the old (i.e., original, unredacted) data element as an input variable (see, e.g., reference numeral 702 in FIG. 7). In the description that follows, this function may be referred to as a “redaction function,” and those of skill in the art will appreciate that many types of such functions may be appropriate or suitable, and may be selected based upon a variety of system- or application-specific factors.

In some implementations, a computer may generate a NIZKP result using the old (original, unredacted) data element as a private argument, and both the new (redacted) data element and the old data element's hash as public arguments. A proof module or other component (such as a NIZKP or other suitable function having similar operational characteristics) may run the correct or sanctioned redaction function, and thereby ensure that a representative hash of the old data element as computed or derived (i.e., hash(old element data)) is the same as a known value of the old element hash that is already in the public domain. This functionality is illustrated at block 703 in FIG. 7.

Finally, as indicated at block 704, a method may also comprise writing, storing, or otherwise recording both a new (redacted) data element, as well as the proof (NIZKP) that validates the new data element, into a database, overwriting the old data element record, and thus deleting it. As noted above, this may be executed or facilitated by a computer or other digital processing instrumentality. This functionality is depicted diagrammatically at the bottom of FIG. 8, which indicates that a record for “Data Element 1” has, after redaction, been replaced by data representative of a “Redacted Data Element 1,” a NIZKP function or result, and an optional “Redaction Type” (discussed in detail below). In the foregoing manner, a system and method of accountably redacting data structures may generally comprise selectively redacting aspects or fields of a particular data element without preserving the original data element, itself, and may do so in such a manner that the redaction may be accountably verified, such as by an NIZKP.

A simple example of a suitable redaction function to enable the foregoing processing (i.e., such as the is_safe_redact function) is as follows. Consider an example data structure where the first twenty bytes of a data element are representative of a party to a transaction's account number and a dollar amount of the transaction, the next twenty bytes are representative of the party's telephone number, and the remaining bytes are representative of other data related to either the party, the transaction, or both. A redaction function (such as is_safe_redact) in this example may be defined in such a manner as to ensure that the first twenty bytes of the data element are unmodified (as they are necessary to consummate the transaction), the next twenty bytes are modified to be zero (as they are unnecessary for the transaction, and may be considered private, regulated, or both), and the remaining bytes are unmodified. This version of a redaction function (which is trivial to implement in most programming languages) may ensure that the telephone number data have all been set to zero (generally an impossible telephone number) and that all other information remains unmodified. It is noted that a system designer, administrator, or other entity may opt to implement multiple types of redaction for a particular application, cryptographic scheme, or other purpose, which may suggest or necessitate implementing multiple redaction functions. For example, one redaction function may be implemented to remove or redact telephone numbers, and another (different) redaction function may be implemented to remove or redact mailing addresses (or aliases, driver license numbers, social security numbers, other types of personally identifiable information, and the like). In this approach, each redaction may be characterized as a “type” in accordance with the type or nature of the specific data being targeted or redacted by that particular function. In the case of multiple redaction types, the redaction type may optionally be stored, in addition to the proof (as indicated at the bottom of FIG. 8). In some instances, the redaction type must be stored if the NIZKP system used does not support determining the original proven program. It is also noted that a single sophisticated or complicated redaction function may remove or redact more than a single data type (or more than one instance of a single data type), eliminating or reducing the need for multiple redaction functions, even in connection with sophisticated or complicated data elements or redaction schemes involving more than one data field or type. Some such sophisticated redaction functions for more complex data elements are described in further detail below.

Those of skill in the art will appreciate that, in some instances, traditional approaches to cryptographic validation of some data structures may be modified to take advantage of the disclosed subject matter. In many current approaches, for instance, a validator or prover may simply ensure that that a hash of each data element is properly referenced in its parents, and that each data element further satisfies any additional rules imposed or enforced by a system designer or administrator. For unredacted elements, this process may remain unchanged in the approach set forth herein. For redacted elements, however, it may be necessary or desirable that a validator or prover, for each redacted data element, additionally validate the NIZKPs and use a pre-redaction hash when checking each parent element.

As in conventional systems, all system designer or administrator rules must also be applied to the data structure to achieve full operability of the disclosed implementations; accordingly, depending on specifics and design choices, such rules may beneficially be modified to support redacted elements. In the telephone number example described above, for instance, a value of all zeros for this field may generally represent a deleted or redacted telephone number (or no telephone number at all), but an absence of (or an invalid entry in) such a data field must be contemplated by (and must not violate) rules governing the underlying data structure. If additional rules selected or enforced by a system designer or administrator require, for example, that every data element comprise a telephone number, then validation would fail after redaction. Accordingly, it may be incumbent upon a system designer or administrator to modify existing rules, to adopt additional rules, or both, to accommodate selective redaction of fields from data elements as described herein.

In some implementations, the previous method directed to redaction of Merkle-Linked data structures may readily be applied selectively to redact data elements in distributed ledgers. By way of example, this may be effectuated in some circumstances by implementing a “redaction transaction” approach, in which a special or dedicated transaction (e.g., to represent an accountable redaction) may be inserted into the distributed ledger itself.

Initially, as in the approach for Merkle-Linked data structure redaction, a system designer or administrator may define a suitable or appropriate redaction function (e.g., such as the is_safe_redact function described above) or a set of such functions. As noted above, it may be desirable to avoid allowing such redactions to impact any additional validation of, or rules governing, the applicable data structure—for example, unqualified redaction of a transaction amount or account information in a financial system may complicate or even prevent validation of a data element intended to be representative of a particular transaction. Additionally, it may generally be desirable to specify, a priori, certain conditions under which a redaction transaction may occur, or the context in which such a redaction transaction may be allowable and authorized, recognized, or otherwise acknowledged by the underlying transaction recordation system. Many techniques (such as digital signatures, smart contracts, timelock puzzles, and other context- or rules-based implementations) are generally known in the art and may be utilized to control or otherwise to govern the circumstances under which a redaction transaction may occur and may be accepted as a mechanism to influence the nature or character of the distributed ledger data structure. The present disclosure is not intended to be limited by such rules or mechanisms employed to acknowledge the propriety or integrity of a particular redaction transaction. It is also noted that, in some situations, it may be desirable to store additional data, such as the rule that authorized the redaction transaction in the first place, in the redaction transaction itself or in a related data record (e.g., for informational purposes, as a design choice, or otherwise at the discretion of the system designer or administrator as a function of application, overall system requirements, cryptographic considerations, or other factors).

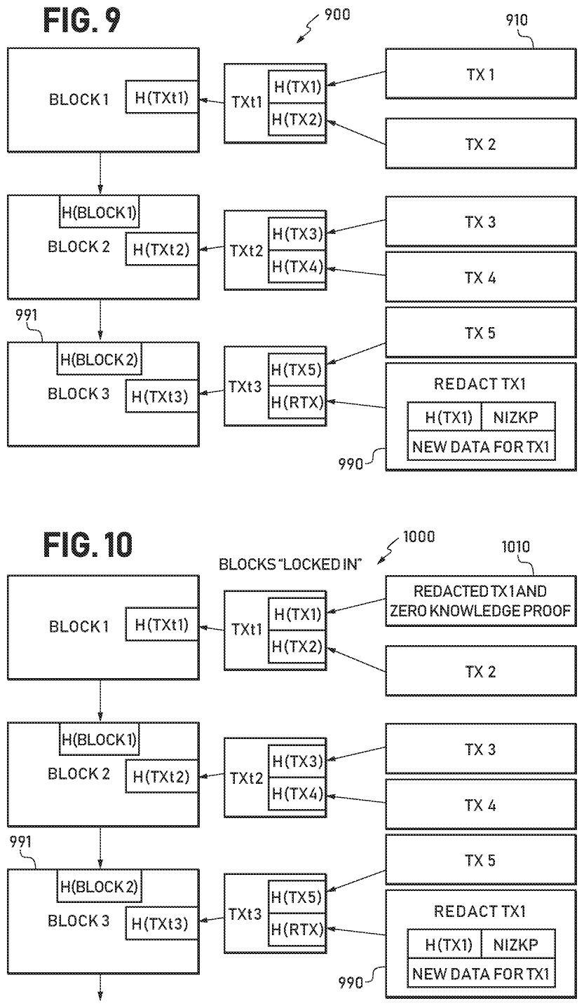

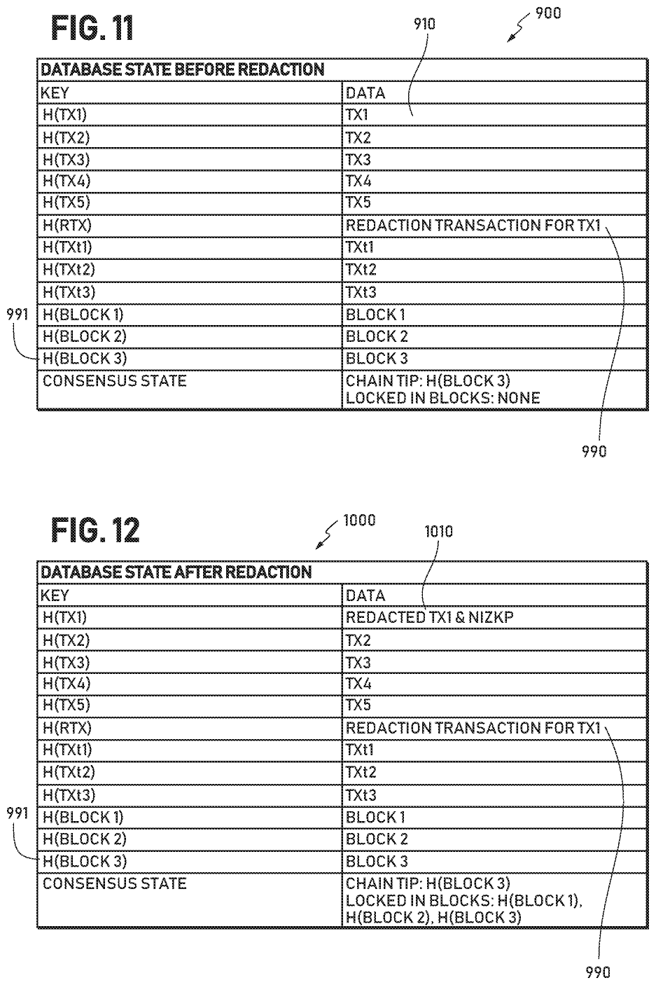

With specific reference to distributed ledger data structures, FIG. 9 is a block diagram illustrating one implementation of a distributed ledger data structure (such as a blockchain) including a redaction transaction before an original version of a redacted data element has been deleted, and FIG. 10 is a block diagram illustrating the distributed ledger data structure of FIG. 9, after redaction. In FIG. 10, data from transaction 1 has been redacted and the original version of the element deleted. FIG. 11 is a diagram illustrating a database state, in the form of a table, prior to application of the redaction approach depicted in FIGS. 9 and 10, and FIG. 12 is a diagram illustrating a database update, in the form of a table, that may result from the redaction approach depicted in FIGS. 9 and 10.

In FIG. 9, data structure 900 generally includes a first transaction data element, TX1 (reference numeral 910) and a redaction transaction data element, Redact TX1 (reference numeral 990). Notably, TX1 910 has not yet been deleted in data structure 900 (this is represented in the top row of the table representation in FIG. 11). In contrast, data structure 1000 illustrated in FIG. 10 generally includes Redact TX1 990 and a redacted version of the first transaction data element, Redacted TX1 (reference numeral 1010); notably, TX1 910 has been replaced (or overwritten) by Redacted TX1 1010. This is represented in the top row of the table representation in FIG. 12.

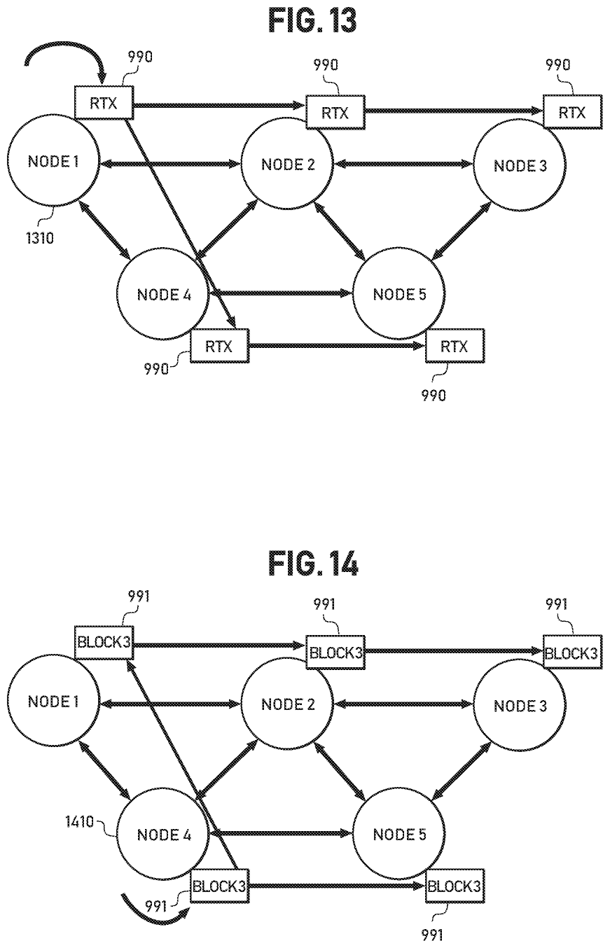

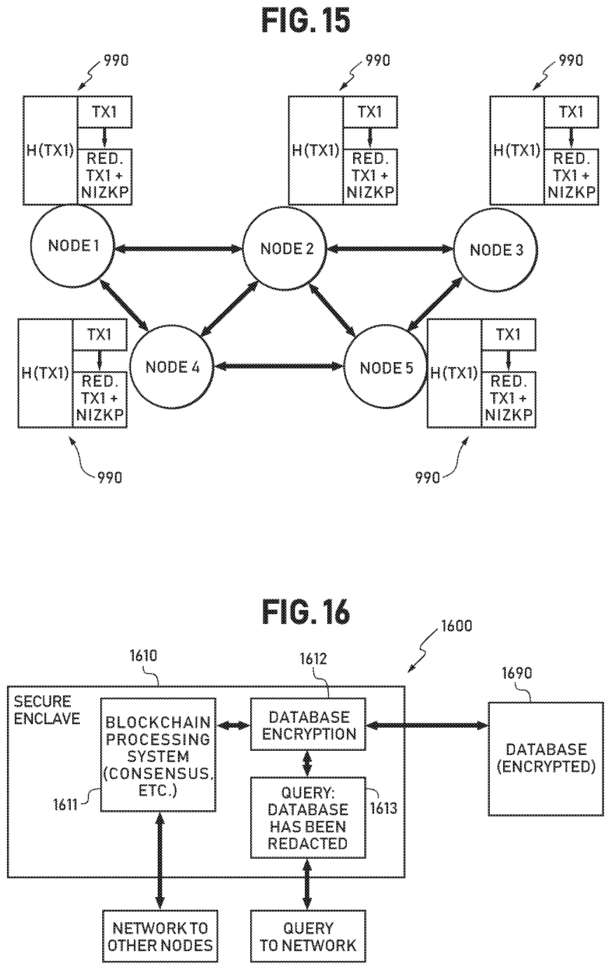

With reference also to FIGS. 13 through 15, it is noted that FIG. 13 is a functional flow diagram illustrating one aspect of a redaction transaction propagating across nodes in a distributed ledger data structure system, FIG. 14 is a functional flow diagram illustrating another aspect of a redaction transaction propagating across nodes in a distributed ledger data structure system, and FIG. 15 is a diagram illustrating aspects of a state of each node in a distributed ledger data structure system following acknowledgement of a redaction transaction.

In the illustrated approach provided by way of example, one redaction process may be implemented by appending a redaction transaction (such as Redact TX1 (or RTX) 990) to a distributed ledger data structure 900/1000 (see FIGS. 9-12). The redaction transaction may generally include the hash of the data element to be redacted (H(TX1)), the new data for the element, and the NIZKP utilized for redaction. This transaction RTX 990 may be included as a new element of the ledger (see FIGS. 11 and 12) and (either subsequently or substantially concomitantly) broadcast across nodes in the network (see FIG. 13). Once the new element containing the redaction transaction RTX 990 is “locked in” to a particular block, such as Block 3 (reference numeral 991) by whatever distributed consensus algorithm is in use by the distributed ledger system (see FIG. 10), then references in each node's internal database may be replaced with the redacted version (FIGS. 12, 14, and 15). This includes references to both the transaction (RTX 990) itself as well as the block (such as Block 3 991) referencing the transaction. In some instances, it may be desirable to design the redaction process to be irreversible once the original version of the data element (e.g., TX1 910) is deleted; in such situations, propagation across every node in the distributed ledger system may not be performed until the redaction transaction (e.g., RTX 990) is guaranteed not to be reversed (i.e., after it is “locked in” in accordance with internal rules governing operation of the distributed ledger).

In the FIG. 13 example, a particular node (in this case, Node 1, reference numeral 1310) may decide or be instructed to redact a blockchain ledger, and so, responsive to such a determination or instruction, Node 1 may create a redaction transaction (such as RTX 990) which will redact a particular transaction (in this case, TX1 910). In practice, RTX 990 is assumed to be well-formed and permissible according to the distributed ledger's internal rules, otherwise it would be rejected for failure to satisfy a necessary criterion or set of criteria governing all transactions in the system. To ensure that RTX 990 is compliant with the distributed ledger system, the node creating the redaction transaction, for instance, or a different node or set nodes determined by the system, may be required to validate the internal structure of RTX 990. In the context of a blockchain ledger, for example, confirmation that RTX 990 refers to an existing data element and that the NIZKP is valid (given the element's content and hash) may be necessary to establish that RTX 990 is permissible. The transaction RTX 990 may then propagate through the network, across all nodes in the system, as illustrated. In the FIG. 13 example, it is assumed that the blockchain had just completed introduction of Block 2 before RTX 990 executed.

In the FIG. 14, example, a particular node (in this case, Node 4, reference numeral 1410) is selected or determined by an operative consensus algorithm to generate the next block (such as Block 3 991) after successful introduction of the redaction transaction (RTX 990). Node 4 then may generate Block 3 991, which may be propagated through the network, across all nodes in the system, as illustrated. As described above, Block 3 991 contains the redaction transaction RTX 990.

At some point after Block 3 991 (which contains redaction transaction RTX 990) has been written to the ledger (see FIG. 12), Block 3 991 is locked in by the consensus algorithm, and the redaction is actually performed in a database at each system node (see FIG. 15).

FIG. 16 is a functional block diagram illustrating aspects of a node structure enabling verifiable redaction using trusted hardware. In accordance with the embodiment illustrated in FIG. 16, a distributed ledger data structure processing system node structure 1600 may generally comprise a distributed ledger database 1690 and a secure enclave 1610 generally comprising trusted hardware components, computers, or processing elements operating in a secure processing environment. As depicted in FIG. 16, enclave 1610 may generally comprise a blockchain (or other distributed ledger) processing system 1611, a database encryption/decryption engine 1612 or other hardware-based mechanism (allowing for secure communications or data transfer between enclave 1610 and database 1690), and a query engine 1613 or other hardware-based mechanism (allowing components of enclave 1610 to query other networks nodes to ensure that a redaction has been effectuated and recorded by system elements external to the node at which enclave 1610 is implemented, or vice-versa). Firewalls, cryptographic elements, network interface elements, distributed ledger administrative components, and the like, have been omitted from FIG. 16 for clarity. Those of skill in the art will readily appreciate how to construct a physical or virtual “clean room,” “sand box,” or other secure processing environment such as enclave 1610 to effectuate or otherwise to facilitate the functionality set forth herein, and the present disclosure is not intended to be limited by any particular hardware components or system architecture implemented at or in cooperation with enclave 1610. Additionally, it may be desirable in some instances to validate the security of enclave 1610, the components operating within the trusted environment, or both, and to distribute results of any validation testing to all the nodes in the system.

FIG. 16 illustrates one embodiment utilizing an optional feature involving utilization of trusted hardware products, computers, or components to validate that every node in a distributed ledger data structure system has actually performed redactions requested or required by the system and its rules. By keeping all unencrypted data within enclave 1610, for example, dedicated hardware or constituent components (such as 1611, 1612, and 1613) may provide a service that can be queried (e.g., by an external node) to ensure that a redaction operation has been accomplished satisfactorily in accordance with rules and current system requirements without exposing data in database 1690. Responsive to a request, a query service, such as query engine 1613, for instance, may return “true” for a given redaction transaction if that transaction has been locked in by the consensus algorithm on the node represented by structure 1600. By querying every other node, for example, node structure 1600 may validate that a redaction has been processed correctly by the network and that any data truly has been redacted from every node in the system.

The foregoing discussion provides a general and highly efficient process to redact blockchains, distributed ledgers, and other Merkle-Linked (or partial Merkle-Linked) data structures by way of example only, and not by way of limitation. However, successful or optimal operation of such a system may generally rely upon selection or determination of an appropriate redaction function (such as the “is_safe_redact” function described above), which is typically a matter of system- or application-specific design choices made by a system designer or administrator. In the case of deleting a section of data from a data element, for example, a suitable redaction function may simply determine or ensure that only the desired section of the data element has been deleted, redacted, or overwritten, and that the remainder of the affected or redacted data element remains unmodified. For redaction of other data types, however, or for more targeted or complicated redactions, more complex redaction function implementations may be better suited, as applications require. Some examples are described below, in which each implementation is described in the context of the previously-described methodologies using simple redaction functions. It is noted that the following disclosure is intended for illustrative purposes only, and that other examples and useful embodiments may fall within the scope and contemplation of the disclosed subject matter.

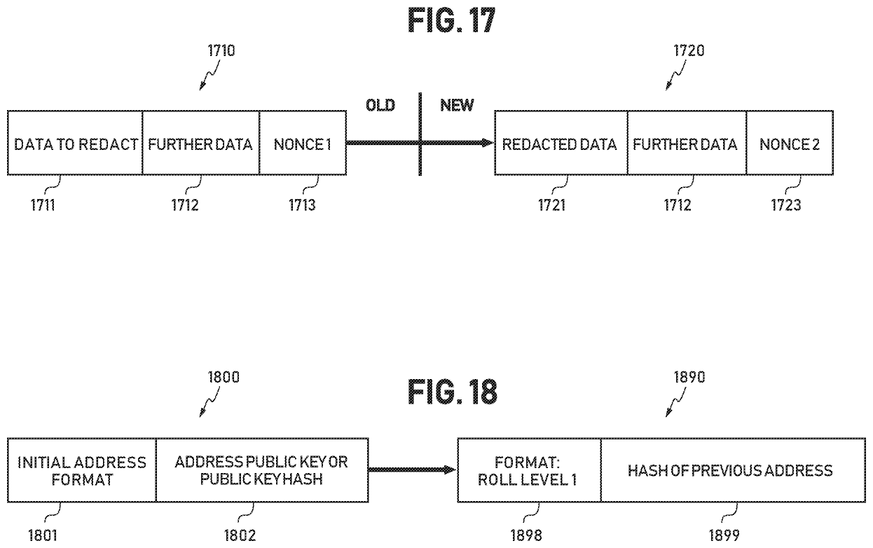

FIG. 17 is a block diagram illustrating aspects of a redaction technique implementing a nonce change. If the data to be redacted from a particular data element are extremely minimal, or easily guessable, then a technique may be employed that is slightly modified from those described above. In such situations involving short or relatively easily ascertainable redactions, it is generally possible to use the original element hash (e.g., H(DE1)) and data from the new element (i.e., the redacted data element) to recover the original data (i.e., original DE1) by simply guessing all possible combinations, for example, using a “brute force” method or a similar approach. To prevent this, a section of random data (called a nonce) may be added to the data element. This is illustrated in FIG. 17, which shows, on the left, an original data element DE1 1710 comprising data to be redacted 1711, additional data 1712 to remain unchanged, and a nonce 1713 (containing random data). FIG. 17 also shows, on the right, a redacted data element DE1 1720 comprising redacted data 1721, additional data 1712 that has remained unchanged, and a new nonce 1723 (containing random data that are different from those in nonce 1713).

During redaction, a new nonce 1723 section (comprising random or pseudorandom data) may be selected for addition, and the old nonce 1713 may be deleted or overwritten. For generation of nonce 1723, it may be beneficial to utilize a random or pseudorandom number generator that is cryptographically secure; any of a variety of such generators generally known in the art may be employed for this purpose. If nonce 1723 section is sufficiently long, its addition to redacted data element DE1 1720 may convert the hash function from a computationally blinding commitment to a mathematically blinding commitment. As a consequence, addition of nonce 1723 may render it impossible to guess the contents of redacted data 1711 even with unlimited computer power, because for every possibility of redacted data 1711, there will be a random or pseudorandom nonce 1723 that generates the original hash (which, as noted above, is shared between DE1 1710 and redacted DE1 1720).

One application in which redaction of unwanted data may have particular utility is in connection with identifying and validating cryptocurrency addresses; in this context, it will be appreciated that an “address” need not be a physical location, but rather any location identifier that may represent a physical place or a physical, logical, or virtual space that is embodied in or comprises a user- or entity-specific digital storage area, such as a password-protected memory location in a database or computer system. In the case of cryptocurrency, for instance, the “address” is a public key or a hash of a public key, not a physical or logical location in a directory or memory space, though in the context of the present disclosure, the term address is not intended to be so limited. In that regard, FIG. 18 is a diagram illustrating aspects of a data structure employing one approach to validating cryptocurrency addresses. In this context, and at least partially because addresses are typically represented as a public key or as a hash of a public key, validation of address correctness has generally been considered impossible in traditional systems. Thus, arbitrary addresses may be added to the data structure and may further be used to store data.

For example, in theory, a financial transaction involving cryptocurrency or other digital representation of monetary value may contemplate transmission of a small amount of money or monetary value to an address having fields such as “Mike's (or other identifier or indicum for a particular intended recipient)” “SSN (social security number or taxpayer identification) is” “555-55-5555 (or other digits or alphanumeric characters sufficient to associate an intended recipient with a particular mechanism for identification)” in a single transaction. Generally, the funds (or a digital or virtual representation of such funds) transmitted to such an address or address fields can no longer be accessed by a system, since a private key for the address is unknown to nodes or other system components other than that owned or operated by the intended recipient. Unfortunately, deleting or ignoring the transaction is not a desirable option, as this may jeopardize the integrity of a financial system (i.e., since it would mean that the monetary value intended to be transferred from one party to the intended recipient would not be sent to an unvalidated or unverified address).

In accordance with one aspect of the disclosed subject matter, a solution to this problem may be introduction of the concept of “address roll,” in which a cryptocurrency address may be replaced by a hash of that address. A version of an appropriate redaction function may then be implemented to redact the original address by computing a hash of the original address, and then ensuring (e.g., to external nodes in the system) that this hash is a new, valid version of the address to be used system-wide for all subsequent transactions. It is noted that in many instances, a transaction validation system may require modifications to accept rolled addresses as valid; this may be implemented as a simple rule change, for instance, facilitating recognition of a hash as a valid address across all system nodes. It is noted that, in some implementations, access the monetary value or actually spending the money sent to a redacted address (e.g., by executing an additional transaction within the financial system) may insert the redacted address data back in to the data structure, however a subsequent re-redaction may mitigate any unwanted or undesirable effects created by such re-insertion.

As noted above, FIG. 18 illustrates one implementation of an address roll redaction technique as set forth above. Originally, an address may be represented by a data structure 1800 comprising an original or initial address format field 1801 and a public key or hash of such a public key (reference numeral 1802). It will be appreciated that address format field 1801 may comprise multiple fields as described above, such as for identifying an intended recipient, user, or “owner” associated with an address, an identifier type (such as back routing number, account number, SSN, taxpayer ID, or the like), and specific data that uniquely identify the intended recipient, user, or owner, given the identifier type. After redaction, however, the original address may be represented by a modified data structure 1890 generally comprising a format field indicative of a “roll level” (reference numeral 1898) representative of the number of times an address has been redacted, and a hash of the original address data 1899. Redaction may be performed multiple times by rolling again and incrementing (or decrementing, depending upon conventions used by the system rules) roll level format 1898. In any event, all nodes in a distributed ledger processing system may be apprised that an address has been redacted, but that a modified data structure such as indicated at 1890 may be valid and should be acknowledged in connection with subsequent transactions.

In some situations, data may be deliberately inserted into a blockchain or Merkle-Linked data structure in the form of an address. The foregoing methodologies allow for redaction or deletion of such addresses without impacting any financial transaction in the ledger; this mechanism is effectively transparent to a user of the system.

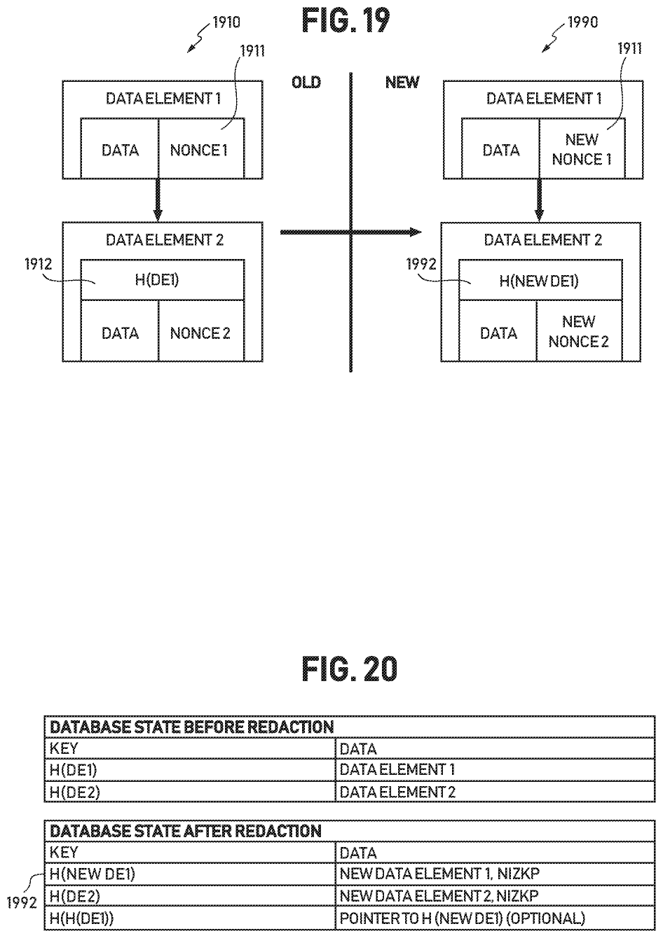

In some situations, data may be deliberately encoded into a hash of a data element, though this is generally regarded as an inefficient method of encoding data into a Merkle-Linked (or similar) data structure, as on average 2ⁿ versions of a data element must be generated for n bits of data encoded. To redact such hashes, a more complex redaction scheme than those set forth above may have utility. FIG. 19 is a diagram illustrating one approach to redacting a hash from a data element, and FIG. 20 is a diagram illustrating a database update, in the form of a table, that may result from the redaction approach depicted in FIG. 19.

FIG. 19 shows a data element structure 1910 from which a hash is to be redacted, and a state of a resulting data element structure 1990 following redaction. In the FIG. 19 implementation, a nonce 1911 of a data element (reference numeral 1910) from which a hash (reference numeral 1912) must or should be redacted is modified (with a new nonce 1991) to create a new data element (reference numeral 1990) with a new hash (reference numeral 1992). Parent elements (such as Data Element 2) may be redacted to update the child hash from the old value 1912 to the new value 1992. This implementation may require that a redaction-enabled transaction system be modified suitably to support redaction of multiple data elements in a single transaction. As indicated in FIG. 19, one aspect of the foregoing redaction function may ensure that all data of a redacted child element (Data Element 1) remains unmodified, but the nonce is affected to the extent that it is changed from an old value 1911 to a new value 1991; with respect to a parent element (Data Element 2), the redaction function may ensure that all data of the element remain unmodified except for the hash reference 1992 to the child. Finally, the database may optionally be updated to store the new hash value 1992 at the key of the hash of the deleted hash (1912). FIG. 20 shows a database state both before and after data element hash removal using the approach described above. Pursuant to this optional technique, a lookup process for any particular data elements may be modified to effectuate or otherwise to facilitate a search for the hash of hashes that fail to be found. This “hash of hash” technique may have utility in the event that, for some reason, a system designer or the system's internal rule structure cannot eliminate all of the original (now redacted) hash values.

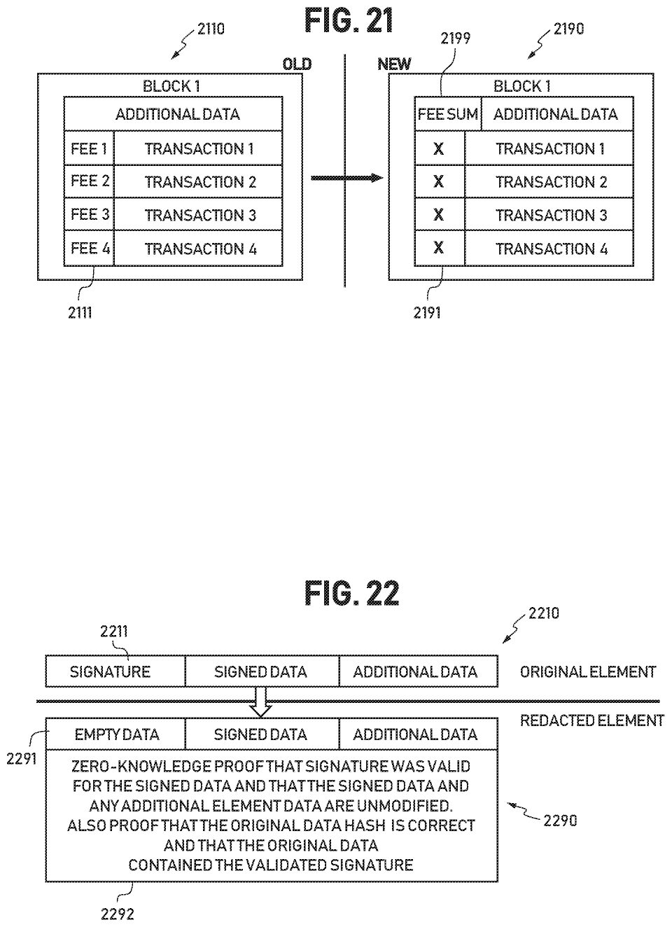

FIG. 21 is a diagram illustrating one data structure modification having utility in redaction of transaction fees in a bitcoin-style blockchain, and FIG. 22 is a diagram illustrating one data structure modification having utility in redaction of signatures from a data element. FIG. 21 shows a data element structure 2110 from which fee information 2111 is to be redacted, and a state of a resulting data element structure 2190 following redaction. Similarly, FIG. 22 shows a data element structure 2210 from which a signature (or information representative of a signature) 2211 is to be redacted, and a state of a resulting data element structure 2290 following redaction.

Transaction fees and amounts represent certain aspects of financial information that is typically encoded in Merkle-Linked (or similar) data structures in many applications, particularly those involving the financial industry, electronic commerce, insurance, cryptocurrency transactions, and the like. It may be beneficial or useful in some instances that the financial information be redacted, particularly in situations in which related or associated information may otherwise be encoded into a data structure via other data fields. By way of example and not by way of limitation, suppose that a donor or sender enters into a series of repetitive transactions in accordance with which the sender sends a recipient numerous $1 and $2 values, with the $1 transactions representing a binary 0 and the $2 transactions representing a binary 1 for each byte of a file. The file would thus be encoded into the financial information of each of the sender's and the recipient's respective banks. As indicated in FIG. 21, an efficient way to redact the transaction fees associated with such multiple transactions may be to sum the fees prior to redaction; similarly, to redact the values or amounts associated with multiple transactions, such multiple transactions to or from a given source may be replaced with a single transaction, the amount or value of which may be computed by summing the amounts of the related multiple transactions. In FIG. 19, for example, individual fees (reference numeral 2111) in data structure 2110 may be summed (reference numeral 2199) for use in data structure 2190, thus allowing redaction of each individual fee (as indicated at reference numeral 2191). The foregoing redaction operations may often easily, or at least readily, be validated within suitable redaction functions. It is noted that redacting certain data from individual transactions or transaction records may require multi-element redaction within a single redaction transaction; further, it may not always be possible to redact transaction amount data, particularly in situations in which doing so may change the financial state of the system. Implementing confidential transactions, as is generally known in the art, may overcome some of these challenges.

As noted above, many Merkle-Linked and similar data structures contain digital signatures, at least partially because these may be useful for authentication or validation purposes in a distributed system. On the other hand, however, it may be useful to redact signatures in some applications, as a signature field may be manipulated (by a third party, hacker, interloper, bad actor, or the like) to contain data that the signatory did not intend or that the system did not expect; in some instances, for example, such manipulation may include situations in which a signatory entity itself deliberately includes data in a signature field, either in addition to or in lieu of actual signature data. In accordance with the foregoing methodologies, a signature 2211 may be redacted from a data structure 2210 by validating the signature within a NIZKP and then validating that the changes to the data element consist solely of redacting the signature 2211—this process generally defines a new data structure 2290 in which the signature 2211 has been redacted or erased (as indicated at reference numeral 2291), but additional material or information 2292 is added to memorialize the validation or verification. A similar or analogous process may be useful when redacting signed data elements (as opposed to redacting the signature itself), though most signatures are applied to the hashes of elements, which are preserved by the redaction techniques described above, so this may not be necessary for most practical applications.

Many types of confidential transactions represent well-known and peer-reviewed solutions for preserving the privacy of amount data in financial and value transaction systems. In most traditional embodiments, confidential transactions work by exploiting homomorphic commitments (such as Pedersen commitments). Unfortunately, since Pedersen commitments (and many other commitments) contain a random or pseudorandom number, they can be generated repetitively to encode information into the system, i.e., these and other random number dependent solutions may insert unwanted data into the ledger. To remove these unwanted data, and thus to reduce, minimize, or eliminate the vulnerability of such paradigms, a redaction may be performed substantially as set forth below.

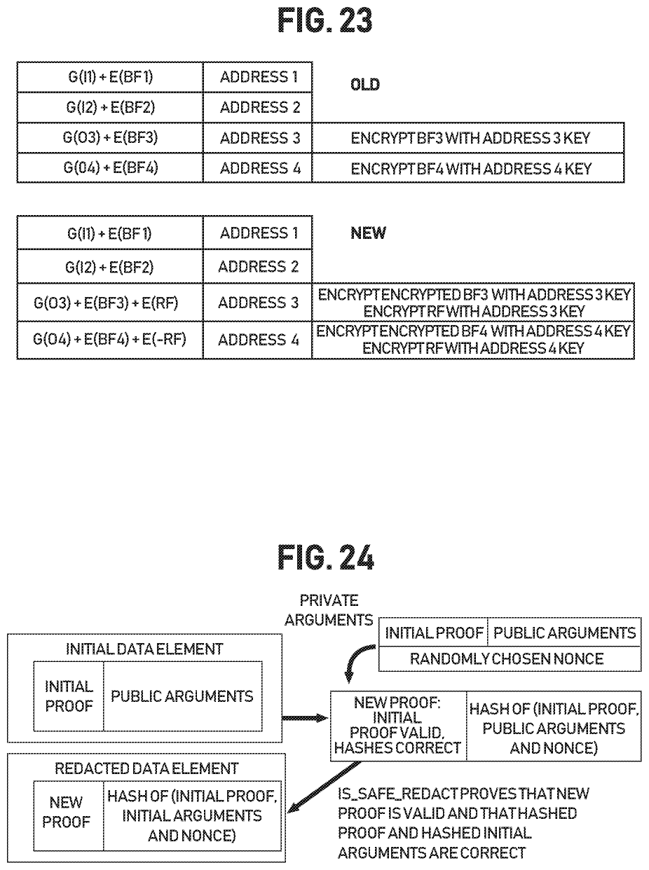

FIG. 23 is a diagram illustrating a data structure of a confidential transaction both before and after certain outputs are redacted. In FIG. 23, an original data structure representing a confidential transaction is illustrated at the top, and a new data structure representing the confidential transaction after redaction is illustrated at the bottom. The functions “G” and “E” represent homomorphic commitment generators, the variables “I” and “0” represent inputs and outputs, respectively, the variables “BF” represent various blinding factors, and RF represents a random (or pseudorandom) value generated in the redaction. In particular, a redaction as illustrated in FIG. 23 may insert an additional blinding factor (represented by E(RF) and E(−RF)) to respective outputs of a transaction, and optionally to the inputs of proceeding transactions. An additional encryption of the blinding factor may be added in order for the receiver of the transaction to open or to access the transaction. Further, it may be necessary in some instances to handle encoding of data in the encrypted information holding the blinding factor. To eliminate or otherwise to redact these data, the data may simply be re-encrypted and a redaction function may be modified to validate that the re-encryption has been performed correctly within the boundary conditions or other rules of the NIZKP.

FIG. 24 is a diagram illustrating one implementation of redaction of a zero-knowledge proof. As set forth above, zero-knowledge proofs (such as NIZKPs) can be a vehicle for encoding data into a Merkle-Linked or similar data structure. Such data may be encoded within the proof itself or in public arguments utilized by the proof. Some proof systems support validation of proofs within other proofs. To achieve redaction, a redaction function (such as the “is_safe_redact” function described above) may be implemented to replace the original NIZKP with a new proof that takes the hash of the original public arguments, and validates that new proof. The new proof takes the old proof and old proof public arguments as private arguments, on the one hand, and the hash of the old proof and old arguments as public arguments, on the other hand. The new proof may prove that the old proof is valid for its arguments, and that those arguments hash to the specified hash input. If the original public arguments and the original proof are short, then a nonce may be needed to prevent data recovery via guessing and checking the hash. As a practical matter, it may be desirable that the nonce is a private argument to the new proof, and is appended to the public arguments during the hash validation. The nonce may then be deleted after redaction lest it be used to guess the initial arguments.

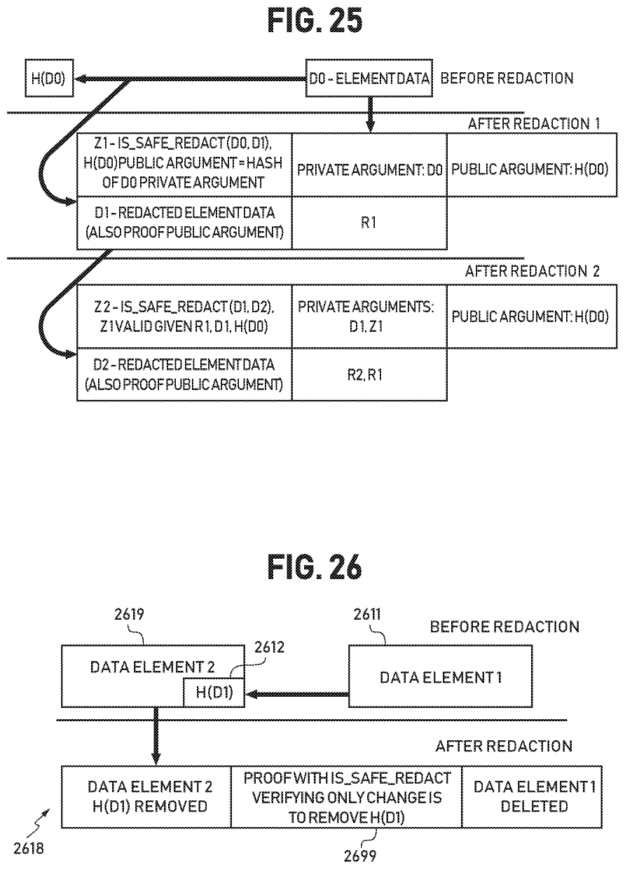

In some circumstances, it may be necessary or desirable to redact a data element that has already been redacted in some manner, or to redact the zero-knowledge proof in connection with or associated with the redaction process. In that regard, FIG. 25 is a diagram illustrating one implementation of a redaction process for performing multiple redactions of a single data element. To enable or to facilitate the process illustrated in FIG. 5, it may be desirable to select or to determine a zero-knowledge proof scheme that supports validation of proofs within proofs, and to employ a version in which a redaction type may be identified (such as described above with reference to FIGS. 7 and 8, for example).

Stepping through FIG. 25 from top to bottom, those of skill in the art will appreciate that, in the illustrated example, D0 represents the original element data, D1 represents the element data after a first redaction, D2 represents the element data after a second redaction, and H(D0), H(D1), and H(D2) represent respective hashes of respective element data. Additionally, R1 represents a redaction type for the first redaction, and R2 represents a redaction type for the second redaction (R1 and R2 may be the same or different). Each of R1 and R2 may be public arguments for the proofs Z1 and Z2 as indicated in FIG. 25; for example, R1 may be used as a public argument for Z1, and R1, R2, or both, may be used as public arguments for Z2. Let Z1 be a zero-knowledge proof for the first redaction; Z1 utilizes H(D0) and D1 (and possibly R1) as public arguments, on the one hand, and D0 as a private argument, on the other hand. Similarly, let Z2 be a zero-knowledge proof for the second redaction; Z2 utilizes public arguments R1 (and possibly R2), D2, and H(D0), and private arguments D1 and Z1. In operation, Z2 is a proof that validates is_safe_redact (or another redaction function) for the section redaction using D1 and D2, and also validates that Z1 is correct given R1, D1, and H(D0). The database may then be updated to store D2, Z2, R2, and R1 at the key of H(D0). Those of skill in the art will appreciate that whether R1 and R2 are employed, and the manner in which they may be employed, are design choices that may be a function of whether redaction type is relevant in a particular system or application, the manner in which proofs Z1 and Z2 are implemented, or a combination of these and a variety of other factors.

The foregoing process (or any of the individual redaction operations) may be repeated an arbitrary number of times by defining a set of proofs Zn which take private arguments of Zn−1, Dn−1, and public arguments Dn, H(D0), and the list of Rn, Rn−1, . . . , R2, R1. Each proof Zn validates the immediately preceding proof, Zn−1, given Dn−1, the list Rn−1, . . . , R2, R1, and H(D0), as well as is_safe_redact(Dn−1, Dn) (or whatever redaction function is implemented by the system). Through repetition of this architecture, any arbitrary or desired number of proofs may be generated for any number of redaction steps for any given element.

In some circumstances, it may be necessary or desirable to redact or to delete an entire data element from the overall data structure, those of skill in the art will appreciate that such a redaction may be extremely difficult, or even impossible, in accordance with overall system rules or instruction sets. For example, deleting a data element from a blockchain may be a violation of a rule intended to govern the integrity of the blockchain system, and an operation seeking to delete a data element, or to redact it from the chain, may not be a permissible action. The principles underlying the foregoing methodologies may be employed, however, to work within the boundary conditions of such a transaction system to enable redaction of entire data elements from a data structure without jeopardizing system continuity or transaction integrity.

One technique for deleting an element may generally involve removing all references to the deleted element within its parent or parents, and modifying the redaction transaction system to support deleting an element entirely by hash. In that regard, FIG. 26 is a diagram illustrating one data element modification facilitating a redaction to delete a child data element. At the top of FIG. 26, there is illustrated a child data element (Data Element 1, reference numeral 2611) referenced by its hash (H(D1), reference numeral 2612) in a parent data element (Data Element 2, reference numeral 2619) prior to redaction. The bottom of FIG. 26 illustrates a new version of the parent 2618 following redaction, i.e., the hash 2612 of the child 2611 has been removed, and additional information 2699 regarding the redaction transaction has been added.

The hash 2612 of the element to be deleted (i.e., child 2611) may be encoded within the redaction transaction. If the hash 2612 must also be removed from the database (e.g., due to internal rules or instructions sets, for efficiency or memory management purposes, or just as a matter of design choice), then the redaction transaction could contain H(H(D1)) instead, and the database may then find the element to be deleted (for other parents, for instance, or at other nodes) by searching hashes of hashes of the elements. The is_safe_redact method (or other redaction function utilized by the system) in this case may validate that the parent 2619, and all other parents referencing deleted child 2611, are unmodified except for removal of the hash 2612 (see block 2699). In practice, the techniques employed for this purpose may involve use of the standard is_safe_redact (or other, generic redaction function) and hash validation methodologies set forth above with reference to FIGS. 5 and 6.

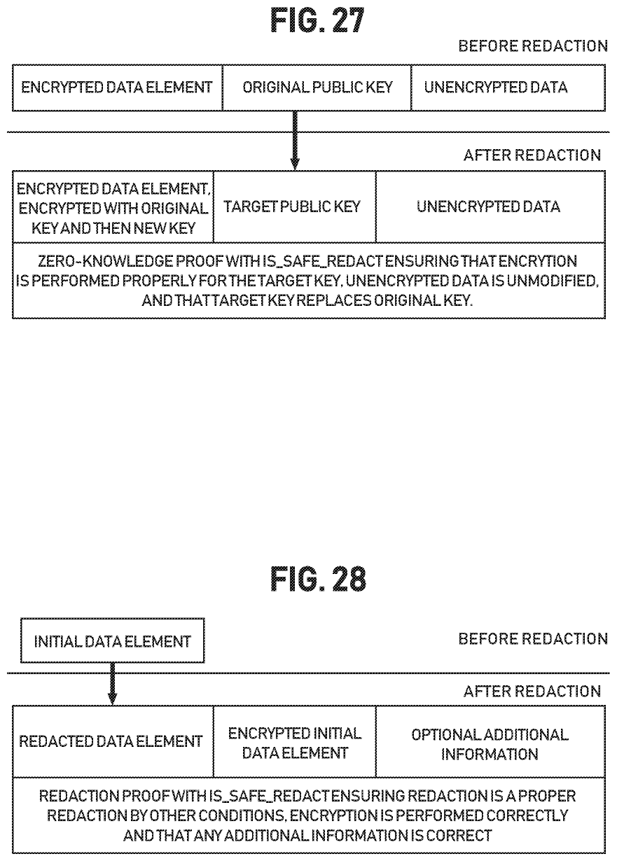

FIG. 27 is a diagram illustrating one data element modification facilitating re-encryption of data in an asymmetric cryptosystem in which it is not necessary to know a private key for original data. Prior to redaction, the data element illustrated at the top of FIG. 27 generally comprises unencrypted data, encrypted data, and an original public key. The bottom of FIG. 26 illustrates a new version of the data element following redaction, i.e., the original encrypted data has been re-encrypted using the original public key and a new (target) public key, and additional information regarding the redaction transaction has been added. Those of skill in the art will appreciate that in the FIG. 27 example, it may be assumed that the decrypter knows both the original private key and the new private key after redaction.

Specifically, encrypted data may be written into Merkle-Linked or similar data structures so that they can only be read by those parties or entities possessing the correct decryption key. If the decryption key is leaked to (or misappropriated by) an unauthorized party, then any such unauthorized party can access the encrypted data. In a traditional database system, this threat of key dissemination may be mitigated by re-encrypting the data with a new key. However, in a Merkle-Linked data structure such as a blockchain, the data are typically immutable and thus cannot be re-encrypted. On the other hand, the redaction methodologies disclosed herein may be used to re-encrypt the data with a new (target) key. The redaction function in this case may be selected to validate taking the encrypted data and encrypting it again with the new target key, thus doubly encrypting the data as illustrated in FIG. 27.

In an asymmetric cryptosystem, data (or selected portions of data) may be double encrypted if the new encryption key (such as the target key in FIG. 27) is known—this may eliminate the need to know the old decryption key. Alternatively, if the original decryption key is known to the redactor, a redaction function may validate de-encrypting the data with the old key and re-encrypting it with the new target key, thus re-encrypting the data. Optionally, depending on the cryptosystem, a NIZKP may need to take random numbers used in the encryption process as private arguments to ensure proper encryption.

As an option to any of the foregoing redaction strategies, it is possible to design in (or to allow interoperability or cooperation with) several approaches for unredacting data. It may be desirable to unredact data in any of a variety of circumstances, and while the foregoing techniques for redacting are robust and may be permanent, a system designer or administrator may desire to reverse the process in some scenarios such as for disaster recovery, auditing the data structure or a series of transactions, or for several other purposes.

One approach to unredacting data is simply to allow a selected or predetermined network node or set of nodes to store an original, unredacted version of the data. This approach has the drawback of not actually redacting those data entirely across all system nodes, but it may at least reduce or minimize the number of places (and the attendant physical or logical resources) where original (unredacted) versions of redacted data are stored.

Another approach to unredacting data is to preserve the original, unredacted data (or “initial” data) in encrypted format within the Merkle-Linked data structure itself; those of skill in the art will appreciate that, in some such instances, it may be beneficial or necessary to preserve or otherwise to retain an encryption key in order to access these data. In this case, an additional NIZKP may be generated to ensure both that the initial data were encrypted properly and that the initial data were, in fact, the same data that were encrypted during the redaction process. In that regard, FIG. 28 is a diagram illustrating one data element modification facilitating redaction with encryption of existing data. In the FIG. 28 implementation, redaction of the original data element may use one of the techniques described above to implement the actual redaction. In the architecture illustrated at the bottom of FIG. 28, the structure includes the redacted data element itself (i.e., including the NIZKP and additional information produced by the redaction function as set forth above), but additionally includes a vestige of the initial data maintained in encrypted form.

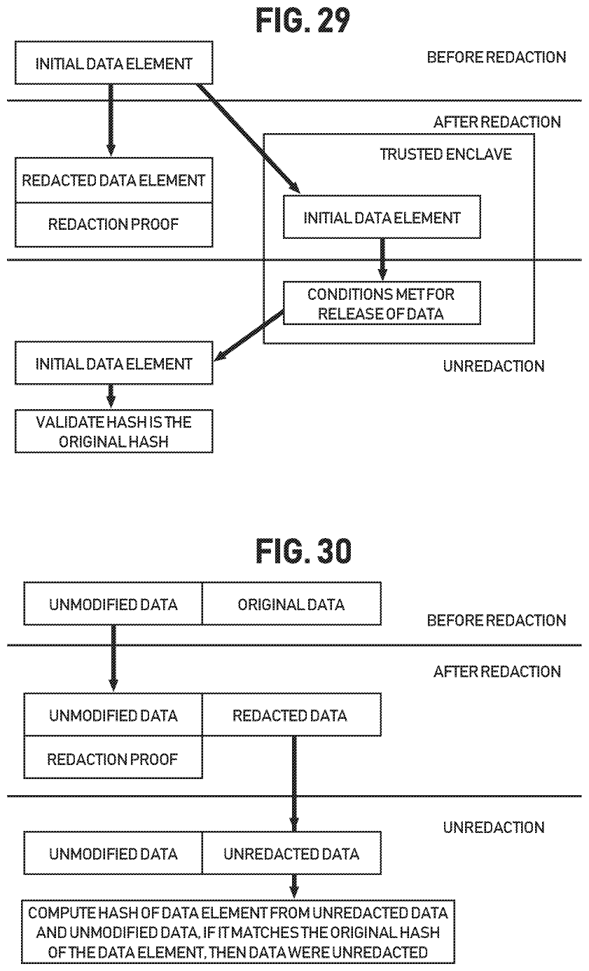

Another approach to unredacting data is to take advantage of trusted hardware to generate an encrypted version of the initial data that may be read only when certain conditions or instruction sets are satisfied, as may be enforced by the trusted hardware. FIG. 29 is a diagram illustrating one implementation of unredaction using trusted hardware. In the FIG. 29 example, the trusted hardware may keep the initial data secret until some conditions selected or determined (e.g., by a system designer or rule set) are satisfied, at which point, the initial data may be output or written to the database. In some implementations, the trusted hardware, either independently or in cooperation with a redaction function or other system- or application-specific code or instruction sets, may ensure that the hash of the data element output by the trusted hardware is that of the original data element (i.e., that the hash was preserved through the redaction process as well as the unredaction process); in the foregoing manner, modification of the initial data within the trusted hardware may be prevented, and external system nodes may be assured that modification has not occurred.

Those of skill in the art will appreciate that such trusted hardware may be embodied in or comprise any of various microprocessor- or microcontroller-based digital processing systems, and may include some or all of the usual or customary attendant hardware or firmware components such as internal or external memory modules or digital storage media (or both), memory controllers, system buses, communications or network interface components including network controllers, and the like. One non-limiting example of such a trusted hardware implementation may comprise an SGX™ environment available from Intel®, though other examples having similar capabilities and utility are currently in use and may be suitable, depending upon application requirements and design choices. In operation, such trusted hardware may be implemented in a manner to enable bi-directional data communications with at least one system node, and it may cooperate with or operate under the influence of or control by software, firmware, algorithms, or instruction sets sufficient to cause the trusted hardware receive initial data, store the same, and analyze rules or conditions, the satisfaction of which may require transmission of the initial data as indicated in FIG. 29 and set forth above. Otherwise, the present invention is not intended to be limited by the specific hardware elements, processing capabilities, communications bandwidth, telecommunications protocols, or other operational characteristics or architectural details of the trusted hardware.

Finally, one more approach to unredacting data is to fail to update an attendant nonce when redacting data. If the nonce is not updated (or simply not present in the first place), then any entity in possession of the original data can validate that it has the correct data by re-inserting the original data into the data element and ensuring the data element hash matches the original hash; similarly, a guesser may recover data using a sufficiently clever or lucky guess, even if the guesser were not in possession of the original data in the first place. This is illustrated in FIG. 30, which is a diagram illustrating one implementation of unredaction of data without a nonce. The drawback to this approach is that, in situations where the original data may be guessed easily, many guesses can be tested quickly to compute a new hash to be compared to the original hash; if the hashes match, that will allow a guesser to validate the guess and to ensure that the original data have been recovered.

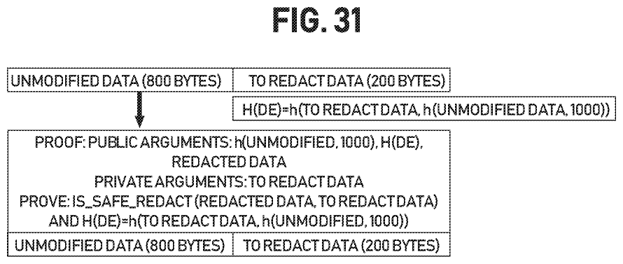

FIG. 31 is a diagram illustrating one implementation of redaction of data with partial hashes. Many hash functions implement hashing by looping over data. It may be possible to improve the performance of redaction by implementing some loops of the hash function inside the NIZKP, and some loops outside the proof. In that regard, hash functions are typically implemented by calling some fixed-length function h(y, z) where z is generally equal to each fixed-length substring of the input data. The initial z is generally the length of the input data. If redaction of only a subset of the string (say the last 200 bytes of a 1000-byte string x) is desired, then the proof may only operate on those last 200 bytes, taking the hash of the first 800 bytes as a public argument (see equation for H(DE) in FIG. 31). In this example, the proof may prove that the redaction was in accordance with the governing redaction function (such as is_safe_redact described above), and may use the computed hash of the first 800 bytes (h(Unmodified Data, 1000)) to compute the hash H(DE). In this situation, verification of the redaction proof may require ensuring that the public hash for the first 800 bytes is in fact the hash of the first 800 bytes of the element. It will be appreciated by those of skill in the art that, if a nonce were used, it may have to be within the redacted section (To Redact Data (200 Bytes) in FIG. 31) of the data string to be effective.

It will be appreciated that aspects of the disclosed subject matter are intended to be interpreted in the context of distributed computer systems. In that regard, the communications pathways and network interactions, such as via the Internet, a wide area network (WAN), a local area network (LAN), a wireless fidelity (WiFi) network, a cellular, satellite, or other telephony network, or other telecommunications network or platform have been omitted from the drawing figures for clarity. Those of skill in the art will appreciate that the disclosed subject matter is not intended to be limited by any particular telecommunications protocol or infrastructure, and that the data communications described herein (such as communications between and amongst nodes and/or any trusted hardware in a distributed system) may be effectuated by any of a number of technologies generally known in the art.

In some embodiments, the nodes and trusted hardware described above may generally be embodied in or comprise any current or future-developed computing system capable of executing one or more instruction sets operative to enable the functionality set forth above. A given node (or its constituent computing systems and components) may be implemented on a single computer or computer server, for example, or it may be distributed across two or more computers or servers; it is also noted that, in this context, a computer or server may be embodied in a physical resource or a virtual resource. For the sake of clarity, the following components are not illustrated in the drawing figures, but for the sake of thoroughness, they are addressed briefly below. System nodes and trusted hardware generally include a processing unit (such as a central processing unit (CPU) or the like), a system memory and a system bus that communicably couples various system components including the system memory to the processing unit. Some examples of commercially available systems operative to provide data processing functionality of nodes or trusted hardware include, but are not limited to, an Atom, Pentium, or 80x86 architecture microprocessor as offered by Intel Corporation, a Snapdragon processor as offered by Qualcomm, Inc., a PowerPC microprocessor as offered by IBM, a Sparc microprocessor as offered by Sun Microsystems, Inc., a PA-RISC series microprocessor as offered by Hewlett-Packard Company, an A6 or A8 series processor as offered by Apple Inc., or a 68xxx series microprocessor as offered by Motorola Corporation.

The processing unit may be any logic processing unit, such as one or more CPUs, microprocessors, digital signal processors (DSPs), application-specific integrated circuits (ASICs), field programmable gate arrays (FPGAs), etc. Generally, the functional blocks of nodes and trusted hardware may be of conventional design and are not described in further detail herein, as they will be understood by those skilled in the relevant art.

Nodes and trusted hardware may also comprise one or more internal non-transitory storage systems or other conventional memory apparatus. Such internal non-transitory storage systems may include, but are not limited to, any current or future-developed persistent storage device such as magnetic storage devices (e.g., hard disc drives), electromagnetic storage devices such as memristors, molecular storage devices, quantum storage devices, electrostatic storage devices such as solid state drives, and the like. Typically, the data structures described herein may be stored or maintained in a database resident on, or distributed amongst, these storage devices. Nodes or trusted hardware may also include one or more optional removable non-transitory storage systems such as magnetic storage devices, electromagnetic storage devices, molecular storage devices, quantum storage devices, and electrostatic storage devices (e.g., secure digital (“SD”) drives, USB drives, or memory sticks), or the like.

The internal non-transitory storage systems and the optional removable non-transitory storage systems communicate with the processing unit via the system bus via suitable interfaces or device controllers communicably coupled between the devices and the system bus, as is known by those skilled in the relevant art. The non-transitory storage devices generally provide nonvolatile storage of computer-readable instructions, data structures (such as described herein), program modules, and other data for operation of the nodes and trusted hardware, as the case may be. Program modules may be stored in the system memory; these may include an operating system, one or more application programs, other programs or modules, device drivers or controllers, and program data, including redaction functions, NIZKPs, and other software or code supporting the distributed ledger or other systems described above.

It will be appreciated that nodes and trusted hardware may also include any number of communications programs and network interface hardware to permit network access and bi-directional data exchange with other systems or components. Specifically, nodes and trusted hardware may operate in a distributed environment using one or more network interfaces communicably to couple to (or engage in data communication or exchange with) one or more remote computers, servers, display devices, other nodes, and/or other devices via one or more communications channels. These logical connections may facilitate any known method of permitting computers to communicate, such as through LANs, WANs, WiFi, Ethernet, etc. Such networking environments are well known in wired and wireless enterprise-wide computer networks, intranets, extranets, and the like.

Several features and aspects of a system and method have been illustrated and described in detail with reference to particular embodiments by way of example only, and not by way of limitation. Those of skill in the art will appreciate that alternative implementations and various modifications to the disclosed embodiments are within the scope and contemplation of the present disclosure. Therefore, it is intended that the present disclosure be considered as limited only by the scope of the appended claims.

What is claimed is:

1. A method of accountably redacting selected data from a data structure, said method comprising:
identifying an original data element in the data structure having a data field to redact;
selectively redacting the data field from the original data element and leaving an unredacted data field unchanged;
applying a proof to verify results of said selectively redacting;
responsive to said selectively redacting and said applying a proof, generating a new data element comprising the unredacted data field and the proof; and
replacing the original data element with the new data element in the data structure.

2. The method of claim 1 wherein said identifying comprises determining that the data field to redact contains personally identifiable information.

3. The method of claim 1 wherein said identifying comprises determining that the data field to redact contains copyrighted material.

4. The method of claim 1 wherein said selectively redacting comprises utilizing a redaction function.

5. The method of claim 1 wherein said utilizing a redaction function comprises overwriting values in the data field to redact.

6. The method of claim 1 wherein said applying a proof comprises comparing a known hash of the original data element with a hash of data used by the proof.

7. The method of claim 1 wherein said applying a proof comprises utilizing a non-interactive zero knowledge proof (NIZKP).

8. The method of claim 7 wherein the NIZKP uses the original data element as a private argument.

9. The method of claim 8 wherein said applying a proof comprises ensuring that a hash of data used by the NIZKP is the same as a known hash of the original data element.

10. The method of claim 1 wherein the data structure is a blockchain and wherein the new data element does not violate a rule of the blockchain.

11. The method of claim 10 wherein said generating comprises associating the new data element with a hash.

12. A non-transitory computer-readable medium encoded with data and instructions enabling accountable redaction of selected data from a data structure; the data and instructions causing an apparatus executing the instructions to perform a method comprising:
identifying an original data element in the data structure having a data field to redact;
selectively redacting the data field from the original data element and leaving an unredacted data field unchanged;
applying a proof to verify results of said selectively redacting;
responsive to said selectively redacting and said applying a proof, generating a new data element comprising the unredacted data field and the proof; and
replacing the original data element with the new data element in the data structure.

13. The method of claim 12 wherein said identifying comprises determining that the data field to redact contains personally identifiable information.

14. The method of claim 12 wherein said identifying comprises determining that the data field to redact contains copyrighted material.

15. The method of claim 12 wherein said selectively redacting comprises utilizing a redaction function.

16. A redacted data element for use in connection with a data structure, said redacted data element comprising:
an unredacted data field from an original data element in the data structure; and
a proof to verify that an additional data field from the original data element has been redacted in the redacted data element and that no other data field from the original data element has been modified;
wherein a second hash associated with said redacted data element is derived from a first hash associated with the original data element.

17. The redacted data element of claim 16 wherein said proof comprises a non-interactive zero knowledge proof (NIZKP).

18. The redacted data element of claim 17 wherein said NIZKP uses the original data element as a private argument to derive the second hash.

19. The redacted data element of claim 18 wherein said proof is operative to ensure that the second hash is derived from the first hash.

20. The redacted data element of claim 16 wherein the data structure is a blockchain.

21. The redacted data element of claim 20 wherein the additional data field comprises personally identifiable information.

22. The redacted data element of claim 21 wherein the additional data field is an address.

23. The redacted data element of claim 18 wherein the additional data field comprises copyrighted material.
